(19) United States
(12) Patent Application Publication
(10) Pub. No.: US 2018/0327086 A1
(43) Pub. Date: Nov. 15, 2018

(54) Gimbaled Rotor Hub Assembly with Spherical Bearing

(71) Applicant: Bell Helicopter Textron Inc., Fort Worth, TX (US)

(72) Inventors: Jaret F. Burgess, Fort Worth, TX (US); Frank Bradley Stamps, Colleyville, TX (US)

(73) Assignee: Bell Helicopter Textron Inc., Fort Worth, TX (US)

(21) Appl. No.: 15/594,588

(22) Filed: May 13, 2017

(51) Int. Cl. B64C 27/32; B64C 27/605; B64C 29/00; B64C 27/06; F16C 19/06

(52) U.S. Cl. CPC B64C 27/32; B64C 27/605; F16C 2326/43; B64C 27/06; F16C 19/06; B64C 29/0033

(57) ABSTRACT

An aircraft rotor assembly has a yoke with at least two arms extending therefrom. The yoke is attached to a mast through a constant-velocity joint, thereby permitting axial tilt of the yoke relative to the mast. Each arm of the yoke includes an axisymmetric elastomeric bearing with a spherical central member and two opposite partially-spherical members attached to the central member. Each axisymmetric bearing cooperates with a cup and a bracket. Each cup is attached to one of the yoke arms and each bracket is attached to a blade cuff.

### BACKGROUND

A rotorcraft includes one or more rotor systems. Design of rotors for aircraft is extremely complex. A large number of factors must be taken into account. Two key design considerations that are always important are weight and simplicity. That is, it is always beneficial to make the rotorcraft as light as possible. It is also a goal to have fewer parts accomplish all the different functions required for the desired performance. Because of the massive forces involved, the gimbaled rotors found on rotorcraft generally include three bearings per blade. Each blade generally includes an outboard centrifugal-force bearing designed to absorb chord and beam loads generated by the blades, as well as allowing rotation to accommodate blade pitching. Each blade generally also includes two inboard shear bearings.

### BRIEF DESCRIPTION OF THE DRAWINGS

FIG. 1 is an oblique view of a tiltrotor aircraft including a rotor hub assembly according to this disclosure.

FIG. 2 is a side view of a rotorcraft including a rotor hub assembly according to this disclosure.

FIG. 3 is an oblique view of a rotor assembly including a rotor hub assembly according to this disclosure.

FIG. 4 is a partially exploded oblique view of the rotor hub assembly of FIG. 3.

FIG. 5 is a partially exploded oblique view of the rotor hub assembly of FIGS. 3 and 4.

FIG. 6 is a cross-sectional view of a bearing of the rotor hub assembly of FIGS. 3-5.

FIG. 7 is a partially exploded oblique view of the rotor hub assembly of FIGS. 3-6.

FIG. 8 is a partially exploded oblique view of the rotor hub assembly of FIGS. 3-7.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

It is desirable to reduce the weight and number of parts included in a rotor assembly. Moreover, it is also desirable to move as much weight as possible as close to the axis of rotation as possible. This can be accomplished by utilizing lighter, stiffer blades and tuning the system with a less rigid yoke. With the use of lighter, stiffer blades and a softer yoke, the stiffness of the bearings becomes less important, and this allows the centrifugal-force bearing to be moved inboard and serve as both the centrifugal-force bearing as well as a shear bearing.

This disclosure serves to further those goals by teaching the novel use of an axisymmetric elastomeric bearing with a gimbaled yoke, the axisymmetric elastomeric bearing acting as an inboard centrifugal force/shear bearing. This configuration provides for a lighter and simpler rotor hub assembly, which provides better performance and lower maintenance costs.

The rotor hub assembly includes a yoke that has at least two arms extending therefrom and defines a central opening extending from a top surface to a bottom surface of the yoke. The yoke is attached to a mast through a constant-velocity joint. The constant-velocity joint permits the yoke to rotate about a variable angle relative to the mast. Blades are attached to the arms of the yoke through two bearings. The first bearing is an inboard axisymmetric elastomeric bearing that includes a spherical central member with a first hemisphere oriented toward the blade and a second hemisphere oriented toward the mast. The inboard axisymmetric elastomeric bearing includes two partially-spherical members. The first partially-spherical member is attached to the first hemisphere of the central member and the second partially-spherical member is attached to the second hemisphere of the central member. The first partially-spherical member cooperates with a concave surface of a cup in contact therewith. The opposing side of the cup is attached to one of the at least two arms. The second partially-spherical member cooperates with a concave surface of a bracket in contact therewith. The bracket has two connector arms extending therefrom enabling the bracket to connect with a blade cuff. The rotor hub assembly may also include a shear bearing at the distal end of each of the yoke arms. This rotor hub assembly serves to further the stated goals of decreasing weight, moving weight closer to the axis of rotation, and decreasing the number of parts.

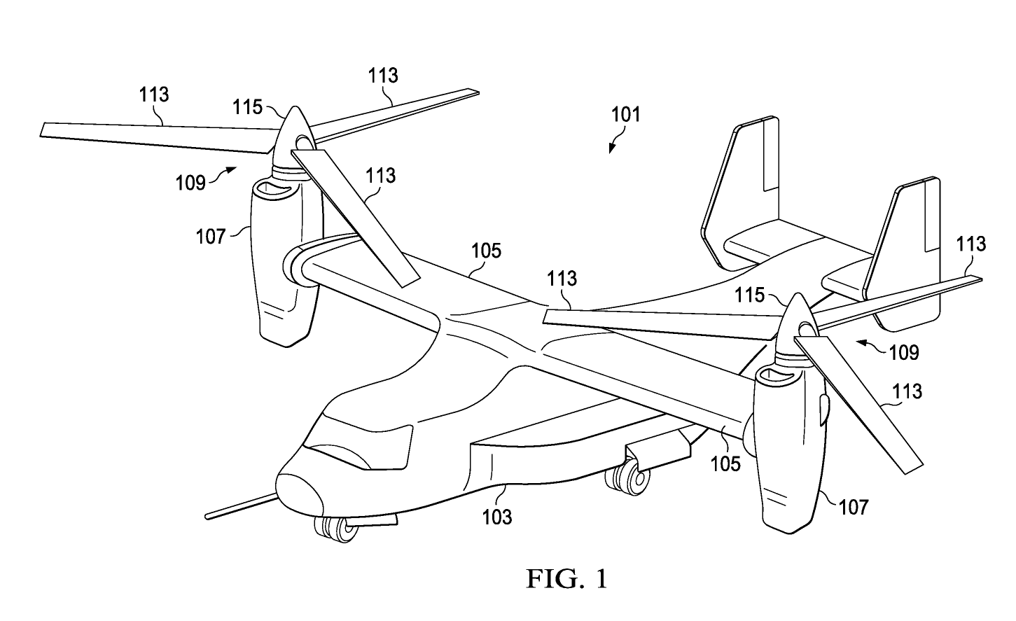

Referring to FIG. 1, a tiltrotor aircraft 101 is illustrated. Tiltrotor aircraft 101 can include a fuselage 103 with a fixed wing 105 extending therefrom. At each end of fixed wing 105 there is a rotatable nacelle 107 housing a powerplant for driving an attached proprotor 109 in rotation, each proprotor 109 having a rotor hub cover 115 and a plurality of blades 113 extending therefrom. The position of proprotors 109, as well as the pitch of blades 113, can be selectively controlled in order to selectively control direction, thrust, and lift of tiltrotor aircraft 101. FIG. 1 illustrates tiltrotor aircraft 101 in helicopter mode, in which proprotors 109 are positioned substantially vertical to provide a lifting thrust.

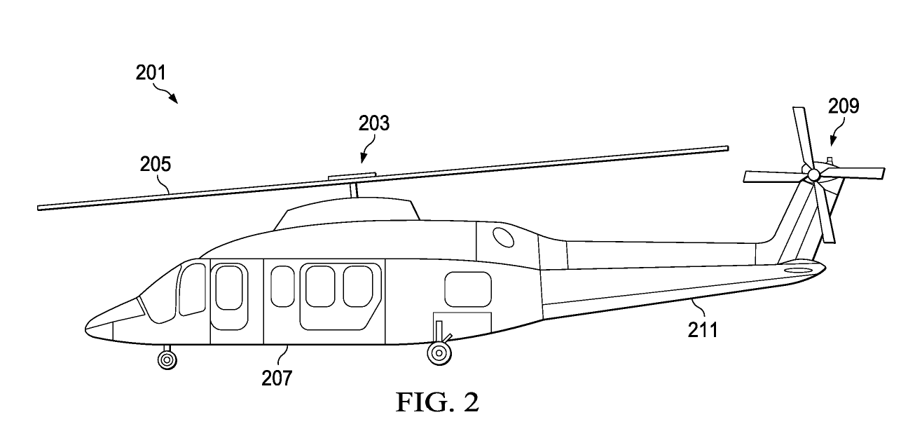

FIG. 2 illustrates a helicopter 201 that may include a main rotor 203 with blades 205, a fuselage 207, a tail 211, and a tail rotor 209. FIGS. 1 and 2 show typical aircraft on which the below described rotor hub assembly may be utilized.

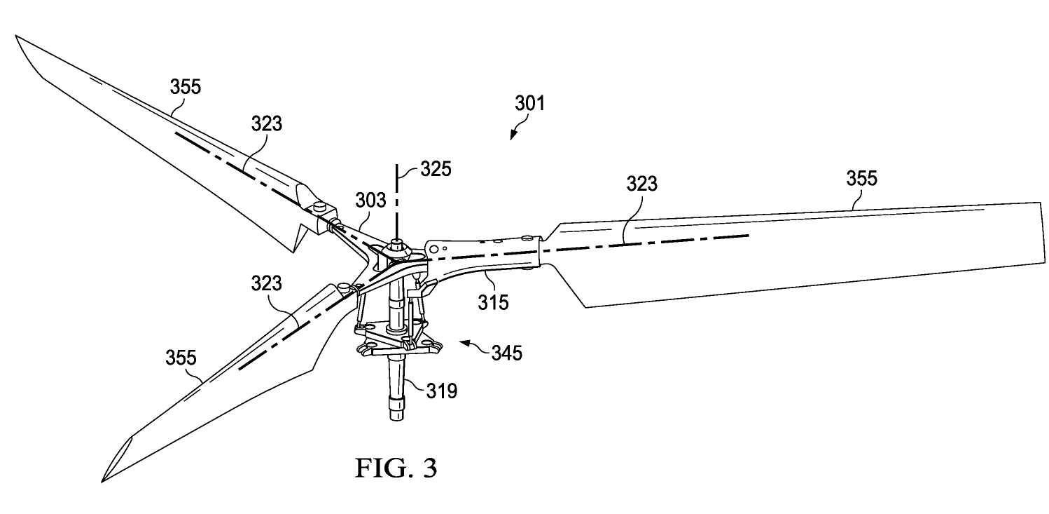

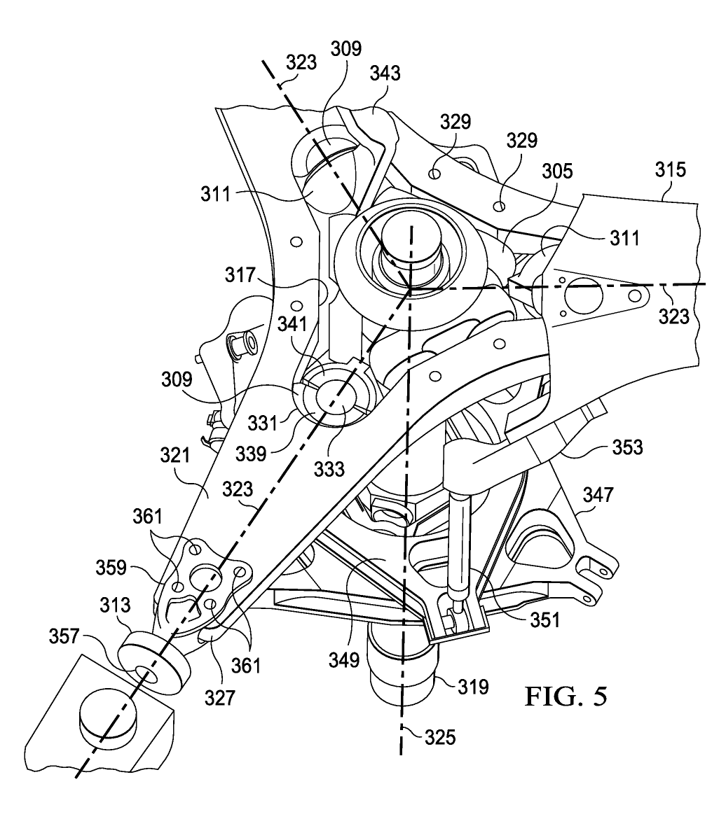

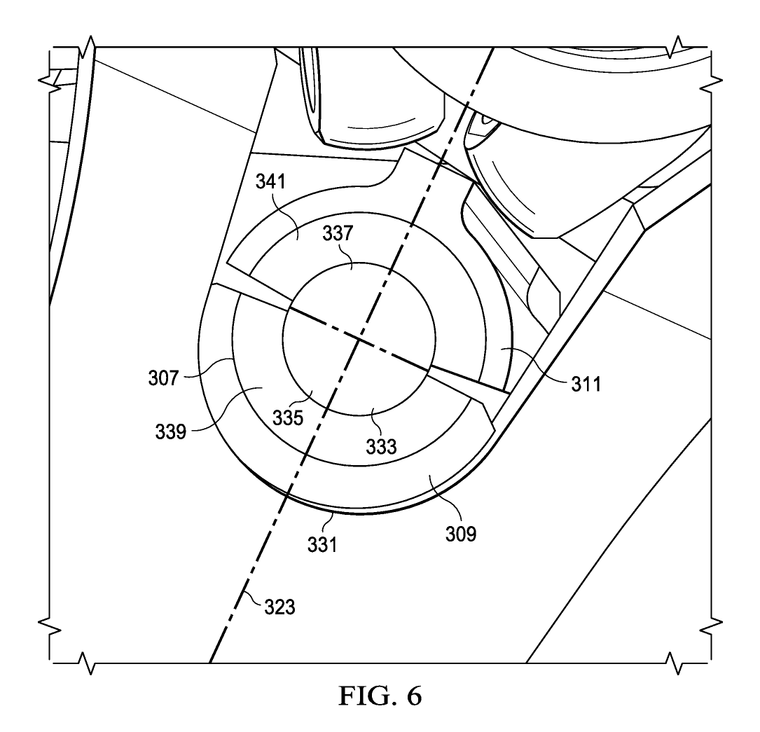

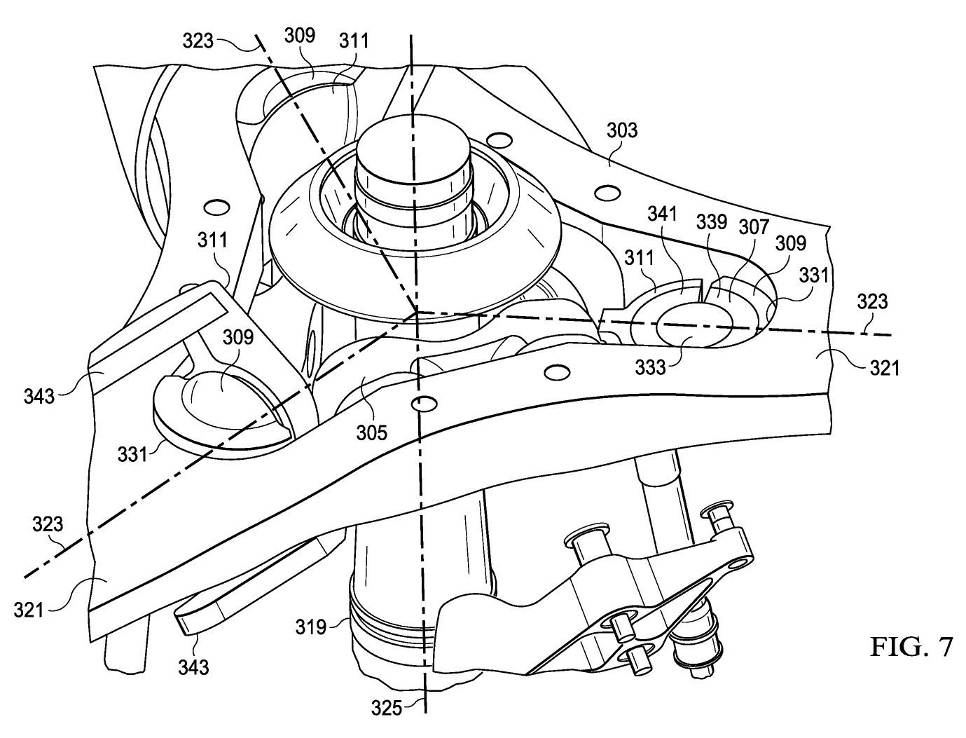

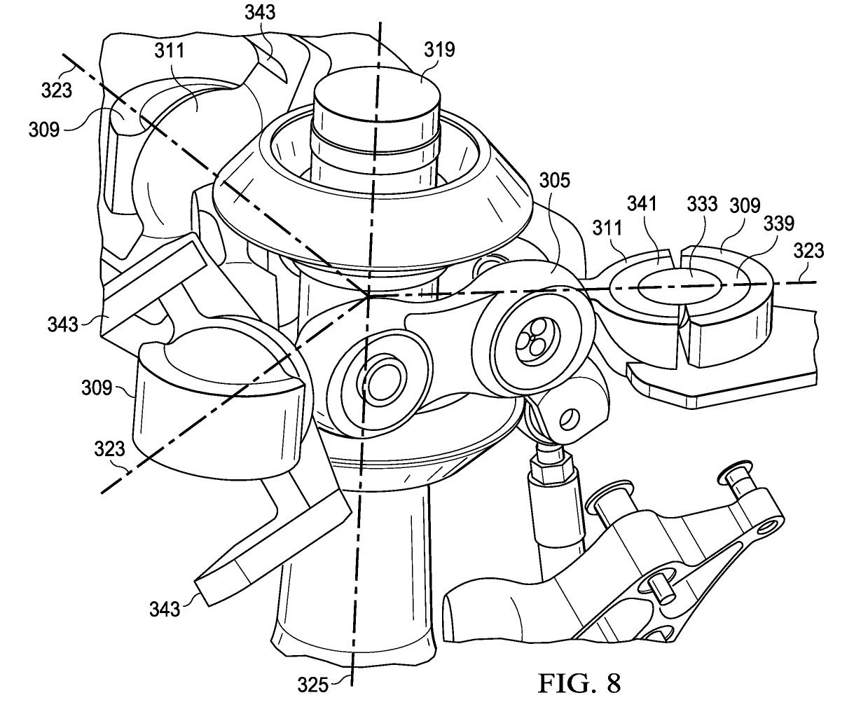

Referring to FIGS. 3-8, a rotor hub assembly 301 is illustrated. Rotor hub assembly 301 may be utilized with either proprotor 109 or main rotor 203. In the embodiment shown in FIGS. 3-8, rotor hub assembly 301 includes a yoke 303, a constant-velocity (CV) joint 305, axisymmetric bearings 307, cups 309, brackets 311, shear bearings 313, and blade cuffs 315. Yoke 303 includes a central opening 317 extending from the top surface to the bottom surface of yoke 303. Central opening 317 is configured to allow a mast 319 to extend therethrough and to house CV joint 305 at least partially therein. As shown, yoke 303 includes three arms 321 extending radially outward. Each arm has a pitch axis 323 extending from the axis of rotation of yoke 303 (shown coaxially with a mast axis 325) through a distal end 327 of arm 321. Yoke 303 may further include openings 329 surrounding central opening 317 to receive hardware to attach upper and lower hub plates (not shown) to yoke 303. The upper and lower hub plates facilitate the transfer of torque from mast 319 to yoke 303 as described in U.S. Pat. No. 6,296,444, which is incorporated herein by reference in its entirety.

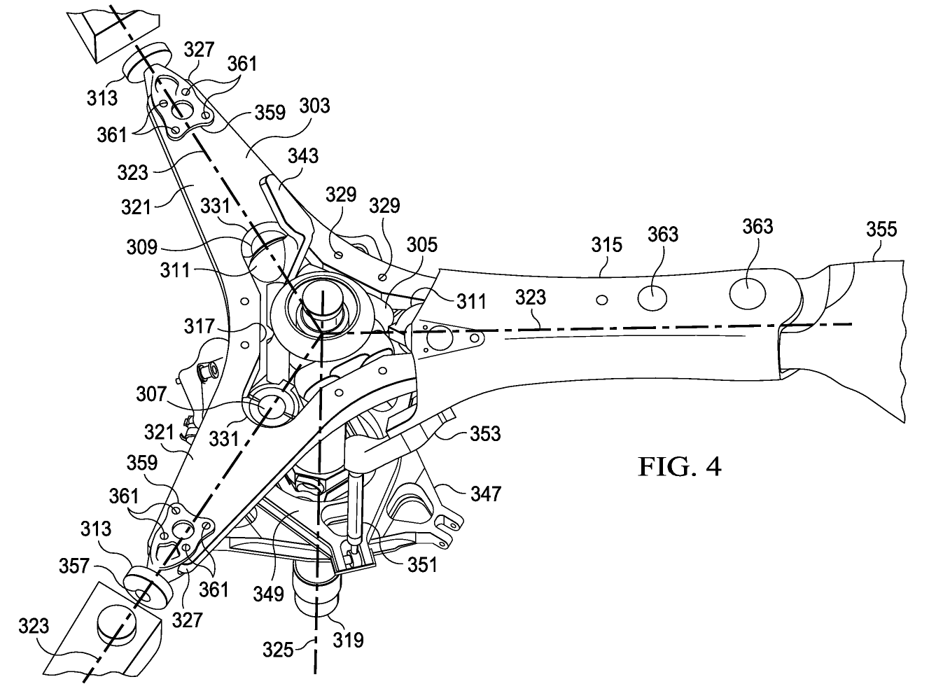

In FIGS. 4-8, at least one of axisymmetric bearings 307 is shown in cross section to show the internal structure. Axisymmetric bearings 307 are located at least partially within central opening 317, adjacent to a proximal end 331 of each arm 321. Axisymmetric bearings 307 should be centered on pitch axis 323. Each axisymmetric bearing 307 includes a spherical central member 333 that includes a first hemisphere 335 and a second hemisphere 337. Each axisymmetric bearing 307 also includes a first partially-spherical member 339 attached to first hemisphere 335 of spherical central member 333 and a second partially-spherical member 341 attached to second hemisphere 337 of spherical central member 333. Spherical central member 333 is made of a rigid material, and first and second partially-spherical members 339, 341 are elastomeric. Alternatively, the first and second partially-spherical members 339, 341 may be made of alternating layers of elastomeric material and rigid material as described in U.S. Pat. No. 9,085,357, which is incorporated herein by reference in its entirety.

Second partially-spherical member 341 cooperates with a concave surface of bracket 311 and first partially-spherical member 339 cooperates with the concave surface of cup 309. One cup 309 is affixed to proximal end 331 of each arm 321 and accepts one axisymmetric bearing 307 partially within. Cups 309 may be affixed to arms 321 using any applicable method of attachment including mechanical apparatuses and/or chemical agents. Cups 309 may include a groove on a convex surface (not shown) configured to receive a portion of arms 321 therein. Cups 309 may further include flanges (not shown) extending from the convex surface configured to extend along the upper and lower surfaces of arms 321. The flanges and arms 321 may include openings extending therethrough to accept connection devices therethrough. Alternatively, cup 309 could be integral to yoke 303 or attached using the composite material from which yoke 303 is fabricated. Each bracket 311 includes a pair of arms 343 extending therefrom. Arms 343 may include outer surfaces configured to match interior attachment surfaces on blade cuffs 315. Blade cuffs 315 and arms 343 may include coaxial through-holes to accept insertion of connection devices therethrough, thereby facilitating attachment of blade cuffs 315 to brackets 311. Accordingly, axisymmetric bearings 307 permit the rotation of brackets 311 and blade cuffs 315 about axis 323. Brackets 311 and cups 309 may be separate from axisymmetric bearings 307, or alternatively, they may be affixed thereto.

Blade pitch is controlled via a swashplate assembly 345. Swashplate assembly 345 includes a non-rotating lower swashplate 347 and a rotating upper swashplate 349. Lower swashplate 347 is connected to the pilot's controls, thereby enabling the pilot to translate lower swashplate 347 along the length of the mast and/or modify the angle of lower swashplate 347. The movements of lower swashplate 347 are mimicked by upper swashplate 349 and passed through pitch links 351 to pitch horns 353. The force applied to pitch horns 353 cause blade cuffs 315 to rotate about pitch axis 323, which rotates blades 355. As discussed above, this rotation about pitch axis 323 is enabled by axisymmetric bearings 307 and shear bearings 313, which are centered on pitch axis 323.

Shear bearings 313 are generally cylindrical in shape and include central openings 357 extending therethrough. Central openings 357 are configured to enable mounting shear bearings 313 on a shear brackets 359. One shear bracket 359 is affixed to distal end 327 of each arm 321. A spindle configured to fit within and cooperate with one central opening 357 extends from the distal end of each shear bracket 359. Each shear bracket 359 includes a plurality of openings 361 to facilitate the attachment of one shear bracket 359 to each arm 321. Each blade cuff 315 should include an interior surface configured to cooperate with an exterior surface of one shear bearing 313 to permit the transfer of shear forces from blade cuff 315 to shear bearing 313 and to enable rotation of blade cuff 315 and shear bearing 313 about pitch axis 323 together. Blade cuffs 315 may include openings 363 to facilitate attachment of blades 355 to blade cuffs 315.

Torque is delivered from an engine (not shown) through a transmission (not shown) to mast 319 that rotates about mast axis 325. Torque is transferred from mast 319 through CV joint 305 to yoke 303. CV joint 305 may comprise a three-link gimbal system, as shown, or any other suitable type joint to permit yoke 303 to rotate about an axis of rotation that is divergent from mast axis 325. For simplicity, some details of the CV joint 305 have been omitted. However, CV joint 305 may be configured similarly to the joint described in U.S. Pat. No. 6,296,444.

It should be noted that, while additional bearings could be used with this system, only two bearings per arm 321 are needed. This is made possible by using lighter, stiffer blades 355 and a more compliant yoke 303. The decrease in weight of blades 355 and increase in flexibility of yoke 303 decreases the importance of stiffness of the bearings. As such, the rotor hub assembly can be made with only one inboard axisymmetric bearing 307 and one outboard shear bearing 313 per arm 321.

At least one embodiment is disclosed, and variations, combinations, and/or modifications of the embodiment(s) and/or features of the embodiment(s) made by a person having ordinary skill in the art are within the scope of this disclosure. Alternative embodiments that result from combining, integrating, and/or omitting features of the embodiment(s) are also within the scope of this disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of this disclosure. Also, the phrases “at least one of A, B, and C” and “A and/or B and/or C” should each be interpreted to include only A, only B, only C, or any combination of A, B, and C.

What is claimed is:

1. A rotor hub assembly, comprising:
a yoke having at least two arms and defining a central opening extending therethrough from a top surface to a bottom surface, the yoke having an axis of rotation extending through the central opening, each of the at least two arms having a pitch axis extending from the axis of rotation of the yoke through a proximal end of the arm and through an opposite a distal end of the arm;
a constant-velocity (CV) joint, the CV joint being configured to engage a mast and transmit torque from the mast to the yoke while enabling the axis of rotation of the yoke to be divergent from an axis of rotation of the mast;
an axisymmetric elastomeric bearing, the bearing comprising:
a spherical central member having a first hemisphere and an opposite second hemisphere;
a first partially-spherical member affixed to the first hemisphere of the spherical central member; and
a second partially-spherical member affixed to the second hemisphere of the spherical central member;
a cup having a concave surface configured to cooperate with the first partially-spherical member of the axisymmetric elastomeric bearing, the cup having a surface opposite the concave surface attached to the proximal end of one of the at least two arms of the yoke; and
a bracket having a concave surface configured to cooperate with the second partially-spherical member of the axisymmetric elastomeric bearing, the bracket having a pair of connector arms configured to connect to a blade cuff, wherein the bracket is configured to rotate about the pitch axis of the at least two arms.

2. The rotor hub assembly of claim 1, further comprising:
a shear bearing attached to the distal end of one of the at least two arms, the shear bearing being configured to rotate about the pitch axis of the arm.

3. The rotor hub assembly of claim 2, wherein the first and second partially-spherical members comprise pluralities of alternatively layered elastomeric members and rigid members.

4. The rotor hub assembly of claim 3, wherein the CV joint comprises a three-link gimbal system.

5. The rotor hub assembly of claim 4, wherein the yoke comprises a fiber composite.

6. The rotor hub assembly of claim 5, further comprising the blade cuff, wherein the blade cuff covers at least a portion of the axisymmetric elastomeric bearing and the shear bearing.

7. A group of bearings for resisting shear and centrifugal forces transmitted between a blade and an arm of a gimbaled yoke of a rotor, the group of bearings consisting of:
an axisymmetric elastomeric centrifugal-force (CF) bearing, the CF bearing comprising:
a spherical central member, the spherical central member having a first hemisphere and an opposite second hemisphere;
a first partially-spherical member affixed to the first hemisphere of the spherical central member; and
a second partially-spherical member affixed to the second hemisphere of the spherical central member;
wherein the axisymmetric elastomeric bearing is configured to be located within an exterior perimeter of the yoke; and
a shear bearing, the shear bearing being configured for attachment to a distal end of the arm of the yoke.

8. The group of bearings of claim 7, wherein the first and second partially-spherical members comprise pluralities of alternatively layered elastomeric members and rigid members.

9. The group of bearings of claim 8, the axisymmetric elastomeric bearing further comprising a cup having a concave surface configured to cooperate with the first partially-spherical member of the axisymmetric elastomeric bearing, the cup having a surface opposite the concave surface configured to attach to a proximal end of the arm of the yoke.

10. The group of bearings of claim 9, the axisymmetric elastomeric bearing further comprising a bracket having a concave surface configured to cooperate with the second partially-spherical member of the axisymmetric elastomeric bearing, the bracket having a pair of connector arms configured to connect to a blade cuff.

11. A rotorcraft, comprising:
a fuselage;
a powerplant;
a mast connected to the powerplant; and
a first rotor system, comprising:
a rotor hub assembly, comprising:
a yoke having at least two arms, the yoke having an axis of rotation, each of the at least two arms having a pitch axis extending from the axis of rotation of the yoke through a distal end of the arm;
a constant-velocity (CV) joint, the CV joint being configured to engage the mast and transmit torque from the mast to the yoke while enabling the axis of rotation of the yoke to be divergent from an axis of rotation of the mast;
at least two axisymmetric elastomeric bearings, each axisymmetric bearing comprising:
a spherical central member having a first hemisphere and an opposite second hemisphere;
a first partially-spherical member affixed to the first hemisphere of the spherical central member; and
a second partially-spherical member affixed to the second hemisphere of the spherical central member;
at least two cups, each cup having a concave surface configured to cooperate with the first partially-spherical member one of the at least two axisymmetric elastomeric bearings, each cup having a surface opposite the concave surface attached to a proximal end of one of the at least two arms of the yoke; and
at least two brackets, each bracket having a concave surface configured to cooperate with the second partially-spherical member of one of the at least two axisymmetric elastomeric bearings, each bracket having a pair of connector arms connected to one of at least two blade cuffs;
a swashplate assembly including a lower non-rotating plate and an upper rotating plate, the upper plate being connected to the at least two blade cuffs by at least two pitch links; and
at least two blades connected to the blade cuffs.

12. The rotorcraft of claim 11, wherein the first and second partially-spherical members comprise pluralities of alternatively layered elastomeric members and rigid members.

13. The rotorcraft of claim 12, further comprising:
at least two shear bearings attached to the distal ends of the at least two arms of the yoke.

14. The rotorcraft of claim 13, wherein the yoke is comprised of a fiber composite.

15. The rotorcraft of claim 14, further comprising:
a second rotor hub assembly including the same components as the first rotor system.

16. The rotorcraft of claim 15, wherein the first and second rotor systems are rotatable relative to the fuselage.

17. The rotorcraft of claim 14, wherein the at least two blades are comprised of a fiber composite.

18. The rotorcraft of claim 14, wherein the CJ joint is a three-link gimbal.
